(19) United States
(12) Patent Application Publication
(10) Pub. No.: US 2003/0044177 A1
(43) Pub. Date: Mar. 6, 2003

(54) Method for the automatic detection of red-eye defects in photographic image data

(76) Inventors: Knut Oberhardt, Foeching (DE); Gudrun Taresch, Munich (DE); Friedrich Jacob, Munich (DE); Tobias Damm, Munich (DE); Hans-Georg Schindler, Holzkirchen (DE)

Correspondence Address: Karl F. Milde, Jr., Esq., MILDE & HOFFBERG, L.L.P., Suite 460, 10 Bank Street, White Plains, NY, 10606, US

(21) Appl. No.: 10/192,711

(22) Filed: Jul. 9, 2002

(30) Foreign Application Priority Data
Sep. 3, 2001 (EP) 01121101.8

(51) Int. Cl. G03B 15/03

(52) U.S. Cl. 396/158

(57) ABSTRACT

In a method for the automatic detection of red-eye defects in photographic image data, image and/or recording data are analyzed independently of one another for several specified indications and/or prerequisites. Thereafter, a value is determined for the presence of the individual indications and/or prerequisites. Thereafter, the determined values are combined for an overall evaluation, and a decision about the presence of potential red-eye defects is made, based upon the overall evaluation. The potential red-eye defects are located, and a decision is made, based upon analysis criteria, as to whether there are, indeed, red-eye defects.

### BACKGROUND OF THE INVENTION

The invention relates to a method for detecting red-eye defects in photographic image data.

Such methods are known from various electronic applications that deal with digital image processing.

Semi-automatic programs exist for the detection of red eyes, where the user has to mark the region that contains the red eyes on an image presented by a PC. The red error spots are then automatically detected and a corrective color that resembles the brightness of the eye is assigned and the correction is carried out automatically.

However, such methods are not suited for automatic photographic developing and printing machines, where many images have to be processed very quickly in succession, leaving no time to have each individual image viewed, and if necessary marked by the user.

For this reason, fully automatic methods have been developed for the use in automatic photographic developing and printing machines.

For example, EP 0,961,225 describes a program comprised of several steps for detecting red eyes in digital images. Initially, areas exhibiting skin tones are detected. In the next step, ellipses are fit into these detected regions with skin tones. Only those regions, where such ellipse areas can be fitted, will then be considered candidate regions for red eyes. In a subsequent step, these ellipse regions are scaled to the shape of the face, whereby only those regions are considered for continued processing, where the scaling results in a size that fits the shape of the face. Two red eye candidates are than sought within these regions, and their distance—as soon as determined—is compared to the distance of eyes. If these last two criteria are met as well, it is assumed that red eyes have been found. These red eyes are then corrected.

The disadvantage of this program for detecting red eyes is its hierarchical structure. Since in the course of the individual steps none of the criteria is detected with absolute certainty, it may be that a “no red eye” decision, that is, an image free of defects, is made as soon as even one of the criteria—even if erroneously—is determined to be not fulfilled. For example, if through unusual lighting conditions the skin tone is not recognized as a skin tone, then there will be no more additional search for red eyes. This method is, therefore, very error-prone.

### SUMMARY OF THE INVENTION

It is, therefore, a principal objective of the present invention to provide a method for the automatic detection of red eyes that operates very dependably, i.e., finds red-eye defects reliably, without erroneously detecting other details as such defects, whereby the analysis of the image data is carried out in a time frame that is suitable for automatic photographic developing and printing machines.

This object, as well as further objects which will become apparent from the discussion that follows, are achieved, in accordance with the present invention, by providing a method for the automatic detection of red-eye defects in photographic image data wherein the image and/or recording data are first analysis independently of one another for several specified indications and/or prerequisites, thereafter, a value is determined for the presence of the individual indications and/or prerequisites. Thereafter, the determined values are combined for an overall evaluation, and a decision about the presence of potential red-eye defects is made, based upon the overall evaluation. The potential red-eye defects are located, and a decision is made, based on analysis criteria, as to whether there are, indeed, red-eye defects.

According to the invention, the image data that are present in digital form and/or the corresponding recording data that are stored at the time the picture is taken are analyzed independently from one another for various indications and prerequisites for red-eye defects. The values resulting from the analysis of individual indications and prerequisites, which are a measure for their occurrence in the image and recording data, are combined to an overall evaluation. At the end, based on this overall evaluation a decision is made, whether possible red-eye defects are present in the analyzed image data or not. Test criteria applied to the candidates are used to clarify, whether the found candidates are indeed red-eye defects. For example, it will be verified that the candidates appear in pairs or are located within a face.

Because the method according to the invention does not analyze various indications or prerequisites hierarchically—as in the aforementioned EP 0,961,225—but independent of one another, it can be avoided that the red eye detection process is terminated as soon as it is erroneously determined that one of the prerequisites or indications is not present. Although one indication or one prerequisite has been determined to be non-existent, other prerequisites and indications are analyzed, and if these are determined to be existent, the overall evaluation may suggest the presence of red-eye defects, even though one indication or one prerequisite is missing. Thus, the method according to the invention can detect red-eye defects even when one of the indications or one of the prerequisites that are analyzed for detecting this defect are not present. For example, if the skin tone of the photographed person deviates from a typical skin tone, or if the person wears a carnival mask and thus the detection method is unable to detect a skin tone in the image, all other indications and prerequisites for red-eye defects that are to be checked may be fulfilled, and the presence of such defects may be determined correctly, while on the other hand, in the method described in EP 0,961,225, the detection method for red-eye defects would have been terminated if no skin tones were to be found in the image.

Advantageously, probabilities can be determined as values for the presence of indications or prerequisites of red-eye defects. Although the method can be carried out if indications and prerequisites are only classified as either present or not present, it is more accurate to determine probabilities for the presence, since most of the indications or prerequisites cannot be analyzed as one hundred percent given or not given. Determining probabilities opens the possibility to enter into the final evaluation a decision of how reliable an indication or a prerequisite could be determined or not. Thus, in addition to the presence of indications and prerequisites, an additional criterion, namely the reliability or unreliability of this determination, enters the evaluation as well, which leads to a much more accurate overall result. In the overall evaluation, an overall probability can be determined from the individual probabilities, where said overall probability becomes a measure, whether red-eye defects are present or not by comparison with a threshold.

Furthermore, it is advantageous to enter the determined values of the presence of indications or prerequisites with a weighting into the overall evaluation. In this manner, it is possible, for example, to categorize the indications and prerequisites into those that are very relevant for the determination of red-eye defects, into those that are a good indication or prerequisite but may not always be present, and into those that occur only occasionally. The fact that these differently categorized indications and prerequisites enter the evaluation in a weighted manner accommodates their relevance, which in turn enhances the accuracy of the decision.

It is particularly advantageous to allow the values for the overall evaluation that have been determined, independently of one another, for the presence of indications and prerequisites to flow into a neural network. Within a neural network, a weighting of the criteria occurs automatically, although it advantageously is carried out during a learning phase of the network using exemplary images. Both the combination of the values for an overall evaluation and the decision, whether potential or actual red-eye defects are present, can be transferred to the neural network. Either binary data—that is, the determination “indications or prerequisites present” or “not present”—or probabilities for the presence of indications or prerequisites can be entered as values in the neural network. However, another form of valuation of the presence, for example a categorization into “not present”, “probably not present”, “probably present” or “definitely present” can be imagined as well. All possible imaginable valuations can be used for determining the values.

In a particularly advantageous embodiment of the method, indications or prerequisites are analyzed simultaneously. Investigating image or recording data simultaneously for indications or prerequisites can save much computing time. This is possibly the fact that allows this method to be used in photographic copy machines of large-scale laboratories, because these units need to process several thousand images in an hour.

Still, investigating image data for the presence of red-eye defects is always a computing time-intensive method. It is, therefore, particularly advantageous to connect in the incoming circuit of the method for detecting a red-eye defect a check of the image or recording data for exclusion criteria. Such exclusion criteria serve the purpose of ruling out such red-eye defects from the outset, thus automatically terminating the process for detecting red-eye defects. This can save a tremendous amount of computing time. Such exclusion criteria may be, for example, the presence of pictures where definitely no flash has been used, or the absence of any larger areas with skin tones, or a strong drop of Fourier transformed signals of the image data, which points to the absence of any detail information—that is, a fully homogeneous image. Any other criteria that are used for red-eye detection, that can be checked quickly and that can, with great reliability, rule out images without red-eye defects are suitable as exclusion criteria. The fact that no red or no color tones at all are present in the entire image information can also be an exclusion criterion.

A particularly significant criterion that—as already mentioned—serves as an exclusion criterion and as a prerequisite for the presence of red-eye defects, is the use of a flash when taking pictures. This is a very reliable criterion, since red-eye defects occur only in images when a picture is taken of a person or animal and the flash is reflected in the fundus (background) of the eye. However, the absence of a flash in an image can only be determined directly if the camera sets so-called “flash markers” when taking the picture. APS or digital cameras are capable of setting such markers that indicate whether a flash has been used or not. If a flash marker has been set that signifies that no flash has been used when taking the picture, it can be assumed with great reliability that no red-eye defects occur in the image.

With the majority of images having no such flash markers set, it can be concluded only indirectly whether a flash picture is present or not. This can be determined, for example, by using an image analysis. In such an analysis, one may look for strong shadows of persons on the background, where the outline of the shadow corresponds to that of the outline of the face; however, the area exhibits a different color or image density. As soon as such very dominant hard shadows are present, it can be assumed with great probability that a flash has been used when taking the picture.

When it is determined that the image is very poor in contrasts, it is an indication that no flash has been used when taking the picture. The determination that the image is an artificial light image—that is, an image that exhibits the typical colors of lighting of an incandescent lamp or a fluorescent lamp—also indicates that no or no dominant flash has been used. A portion of the analysis that is carried out to determine if a flash has been used or not can already be done based on the so-called pre-scan data (the data arising from pre-scanning). Typically, when scanning photographic presentations, a pre-scan is performed prior to the actual scanning that provides the image data. This pre-scan determines a selection of the image data in a much lower resolution. Essentially, these pre-scan data are used to optimally set the sensitivity of the recording sensor for the main scan. However, they also offer, for example, the possibility to determine the existence of an artificial light image or an image poor in contrasts, etc.

These low-resolution data lend themselves to the analysis of the exclusion criteria because their analysis does not require much time due to the small data set. If only one scan of the images is carried out or if only high-resolution digital data are present, it is advantageous to combine these data to low-resolution data for the purpose of checking the exclusion criteria. This can be done using an image raster, mean value generation or a pixel selection.

To increase the reliability of the assertion about the presence of a flash picture or the absence of a flash when the picture has been taken, it is advantageous to check several of the criteria mentioned above and to combine the results obtained when checking the individual criteria to an overall result and an assertion about the use of a flash. To save computing time, it is advantageous here as well to analyze the criteria simultaneously. The evaluation may be carried out using probabilities or a neural network.

Additional significant indications to be checked for the automatic detection of red-eye defects are adjacent skin tones. Although there will definitely be images that do not exhibit adjacent skin tones yet will have red-eye defects (e.g., when taking a picture of a face covered by a carnival mask), this indication may be used as an exclusion criterion to limit the pictures that are analyzed for red-eye defects if one accepts a few erroneous decisions.

However, it is particularly advantageous to check this criterion along with others in the image data and to enter them as one of many criteria into an overall evaluation. This would ensure that red-eye defects could be found even in carnival pictures, in pictures of persons with other skin tones or taken with a very colorful, dominant lighting, where the skin tones are altered. Although the “skin tone indication” is absent in such pictures, all other analyzed criteria could be determined with such high probability or so reliably that the overall evaluation indicates or suggests the presence of red-eye defects, even with the absence of skin tones. The method described in the aforementioned EP 0,961,225 would, on the other hand, terminate the red-eye detection process due to the absence of skin tones, possibly resulting in an erroneous decision.

However, if skin tones are present in an image, it can be assumed that it is picture of a person, where the presence of red-eye defects are much more probable than in all other images. Thus, this criterion may be weighted more strongly. In particular, adjacent skin tones can be analyzed to see if they meet characteristics of a face—such as its shape and size—since with the probability of it being a face, the probability of there being red-eye defects increases as well. In this case, the criterion may be even more meaningful.

If the analysis of skin tones is used as an exclusion criterion, where in their absence red-eye defects are no longer sought, it is also sufficient to use the pre-scan data or corresponding data sets that are reduced in their resolution. If no skin tones appear in these low-resolution data, then reliably no large adjacent skin tone areas are present in the images. This is to say that it may be sensible to forego the detection of red eyes in very small faces, or in images that exhibit small faces, in order to save computing time.

Since the presence of a face in the image data is a very meaningful indication for a potential occurrence of red-eye defects, it is also possible to subject the image data to a face recognition process to determine whether faces are present in the image data. “Face finders” such as the ones used in person recognition are suitable for this purpose. These operate in real time and are, therefore, fast enough for copy machines. Furthermore, such state-of-the-art face finders recognize faces very reliably. Such methods are based on finding density progressions in image data that correspond to density progressions in model faces. Templates, shapeable grids or eigenvectors may be used to compare the density progressions. If such a face recognition method is used, it may be possible to skip the search for adjacent skin tones. However, since these face finders are very computing-time-intensive, it is often more advantageous to use the face recognition method only if skin tones are detected in images.

An additional prerequisite for the occurrence of red-eye defects to be checked is the presence of red, round spots. If no red round spots are found in an image, or possibly if no red areas are to be found at all, it can be assumed that no red-eye defects are present. Thus, this prerequisite for red-eye defects can be used not only as a good exclusion criterion, but also as a very strong criterion for the presence of potential red-eye defects as an input value in a neural network or as a basic value for an overall evaluation. However, since the red spots of red-eye defects are generally rather small in size, this prerequisite must be analyzed using the data of the main scan or corresponding high-resolution data because the data of the pre-scan have too low a resolution for this criterion. Thus, it would only be useful as an exclusion criterion if another analysis is made, after the main scan, to determine whether the red-eye detection process is to be used or not. However, since the analysis of high-resolution data requires much time, it is more advantageous to perform the search for red spots only in the course of the red-eye detection process.

Building on the same prerequisite offers another advantageous indication that portends to the presence of red-eye defects. This indication is based on the fact that with the reflection of the flash in the fundus of the eye, a certain portion of the light is reflected back directly and appears in the image as a white dot inside the round, red spot of the red-eye defect. Thus, a red-white combination is sought as an indication. If such a red-white combination is found, it will be analyzed to see if the red area is round and the white point is located inside the red area. It is furthermore advantageous to analyze the found red-white combination, whether it may potentially be a small, red, round area with a dark border of the iris within a larger, white area of the eyeball. This type of red-white combination may also be used as an indication for the occurrence of red-eye defects. It is advantageous to search for red and white areas independently and simultaneously and to analyze subsequently, whether these areas appear in combination. If this is the case, the color and/or the shape or the density progression of the combination can be analyzed in order to determine, whether it is a combination of a red-eye defect with a light reflection or with an eyeball.

An additional advantageous indication for the occurrence of red-eye defects is the presence of detailed structures in the image data. No detailed structures will be found in very homogenous images where, for example, pictures are taken of the sky and the ocean or the sky and the beach, etc., because neither persons nor objects are represented. No red-eye defects will occur here as well. Red-eye defects will occur when pictures of persons are taken in front of a background or in groups. Pictures of persons, portraits or group pictures show many detailed structures. Fourier transformed signals can be used to analyze whether an image contains many structures or whether it is a homogenous image. If the Fourier transformed signals drops significantly even at low frequencies, it can be assumed that few structures are represented in the image; on the other hand, with a flat progression of the Fourier transformed signals, it can be assumed that the image contains structures and therefore, the possibility for the presence of red-eye defects.

After the decision about the presence of potential red-eye defects is made, it is advantageous to add an analysis process that can be used to check, whether the found candidates are indeed red-eye defects. The analysis of the candidates can be carried out, for example, such that for one potential red-eye defect, a second possible red-eye defect is sought that fits in distance and orientation to the first detected red-eye defect, such that both together are identified as belonging to a pair of eyes.

To analyze possible defects, it is very advantageous to employ a face recognition method—such as has already been described for the detection of red-eye defects. Since it is very computing time intensive, it is preferred to use this method as an analysis tool rather than as an indication. The time factor does not have as negative an impact during the analysis since only a few selected images need to be analyzed. On the other hand, if it were used as an indication for possible defects, many images would have to be processed using the same time-intensive method. Starting from a potential red-eye defect and using a face recognition method, the analysis attempts to find a face in the contents of the image that includes an eye at the position of the potential red-eye defect.

In particular, the already mentioned person recognition methods that search for faces in images that have been recorded using a video camera in rooms that need to be monitored are suited for this task. To this end, the images are converted to low-resolution gray-scale images. Density progressions that correspond to density progressions in reference faces are then investigated in these reduced image data. A similarity value is then generated for the reference face density progression that corresponds most closely to the one found in the image. If the similarity value is very high, that is, the correspondence of the density progression is very good, it can be assumed that a face is present at the respective location of the image. Such face recognition methods are based on the fact that facial features such as eyes, eyebrows, nose, mouth, chin, etc. through their connection with the remaining face reflect typical density progressions; they are, therefore, much more specific than criteria such as skin tone recognition or fitting of an ellipses into the found skin area that have been used thus far in red-eye detection methods. After all, the latter can barely make a distinction between faces and hands, or pumpkins, in the worst case.

As soon as a fitting face is found for the potential red-eye defects, the defects are considered confirmed and are then corrected.

The description thus far has considered individually finding a face for each potential red-eye defect. To do this, all possible orientations must be analyzed, making the method very elaborate and time consuming.

The face recognition method for analyzing potential red-eye defects is less elaborate, if pairs of potential defects are formed prior to applying the face recognition method. If two potential defects that fit to one anther can be found, the orientation of a potential face is already determined. Starting with the potential eyes, the face can only be directed up or down. Through the pair formation, computing time can again be saved when searching for a face. The disadvantage is that profile pictures with a single red eye cannot be found.

For a full understanding of the present invention, reference should now be made to the following detailed description of the preferred embodiments of the invention as illustrated in the accompanying drawing.

### BRIEF DESCRIPTION OF THE DRAWING

FIG. 1, comprised of FIGS. 1A, 1B and 1C, is a flowchart of an exemplary embodiment of the method according to the invention.

### DESCRIPTION OF THE PREFERRED EMBODIMENTS

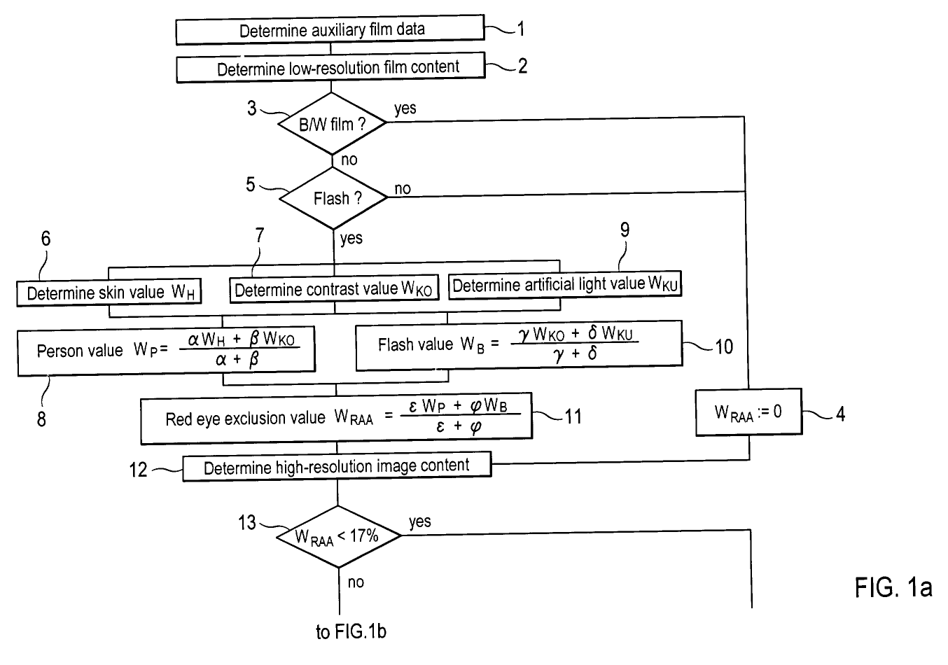

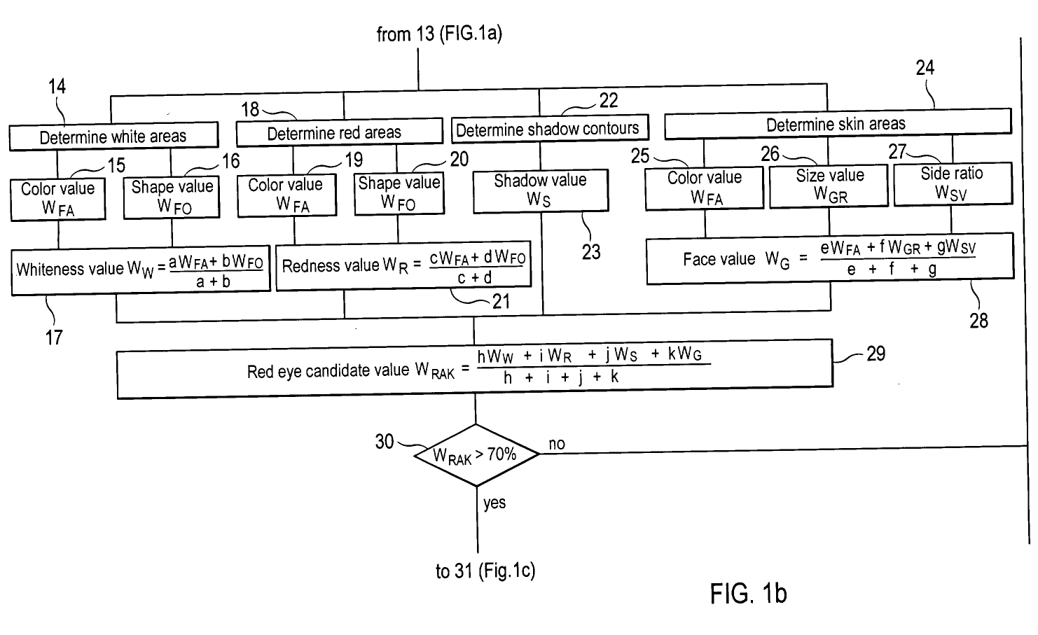

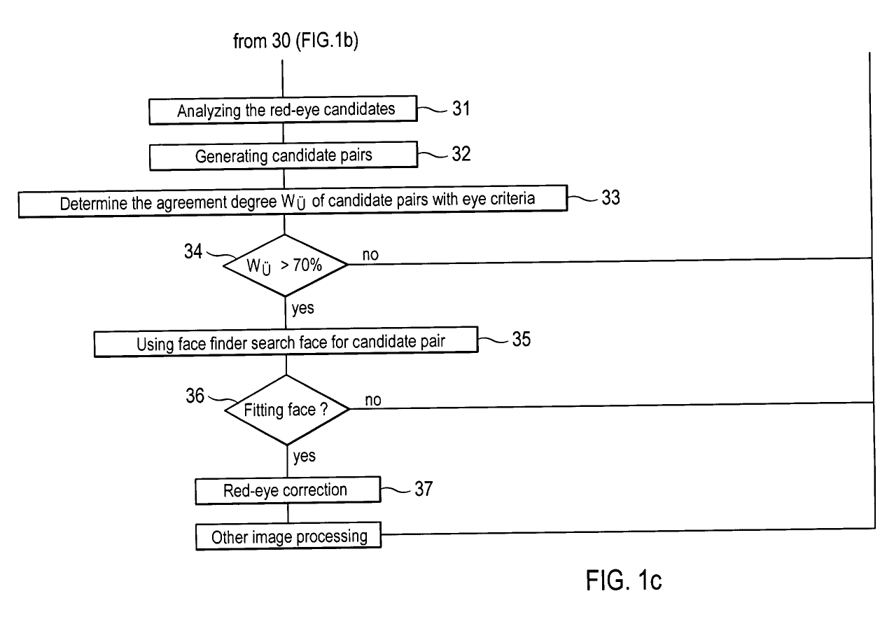

An advantageous exemplary embodiment of the invention will now be explained with reference to the flowchart of FIG. 1.

In order to analyze image data for red-eye defects, the image data must first be established using a scanning device, unless they already exist in a digital format, e.g., when coming from a digital camera. Using a scanner, it is generally advantageous to read out auxiliary film data such as the magnetic strip of an APS film using a low-resolution pre-scan and to determine the image content in a rough raster. Typically CCD lines are used for such pre-scans, where the auxiliary film data are either read out with the same CCD line that is used for the image content or are collected using a separate sensor. The auxiliary film data are determined in a step 1, however, they can also be determined simultaneously with the low-resolution film contents, which would otherwise be determined in a step 2. The low-resolution image data can also be collected in a high-resolution scan, where the high-resolution data set is then combined to a low-resolution data set. Combining the data can be done, for example, by generating a mean value across a certain amount of data or by taking only every x^{th} high-resolution image point for the low-resolution image set. Based on the auxiliary film data, a decision is made in a step 3 or in the first evaluation step, whether the film is a black and white film. If it is a black and white film, the red-eye detection process is terminated, the red-eye exclusion value W_{RAA} is set to Zero in a step 4, the high-resolution image data are determined, unless they are already present from a digital data set, and processing of the high-resolution image data is continued using additional designated image processing methods. The process continues in the same manner if a test step 5 determines that a flash marker is contained in the auxiliary film data that indicates that no flash has been used when taking the picture. As soon as such a flash marker has determined that no flash has been used when taking the picture, no red-eye defects can be present in the image data set. Thus, here too the red-eye exclusion value W_{RAA} is set to Zero, the high-resolution image data are determined, and other, additional image processing methods are started. Using the exclusion criteria “black and white film” and “no flash when taking picture”, which can be determined from the auxiliary film data, images that reliably cannot exhibit red-eye defects are excluded from the red-eye detection process. Much computing time can be saved by using such exclusion criteria because the subsequent elaborate red-eye detection method no longer needs to be applied to the excluded images.

Additional exclusion criteria that can be derived from the low-resolution image content are analyzed in the subsequent steps. For example, in a step 6, the skin value is determined from the low-resolution image data of the remaining images. To this end, skin tones that are an indication that persons are shown in the photo are sought in the image data using a very rough raster. The contrast value determined in a step 7 is an additional indication for persons in the photo. With an image that is very low in contrasts, it can also be assumed that no persons have been photographed. It is advantageous to combine the skin value and the contrast value to a person value in a step 8. It is useful to carry out a weighting of the exclusion values “skin value” and “contrast value”. For example, the skin value may have a greater weight than the contrast value in determining whether persons are present in the image. The correct weighting can be determined using several images, or it can be found by processing the values in a neural network. The contrast value is combined with an artificial light value determined in step 9, which provides information whether artificial lighting—such as an incandescent lamp or a fluorescent lamp—is dominant in the image in order to obtain information whether the recording of the image data has been dominated by a camera flash. Contrast value and artificial light value generate a flash value in step 10.

If the person value and the flash value are very low, it can be assumed that no person is in the image and that no flash photo has been taken. Thus, the occurrence of red-eye defects in the image can be excluded. To this end, a red-eye exclusion value W_{RAA} is generated from the person value and the flash value in a step 11. It is not mandatory that the exclusion criteria “person value” and “flash value” be combined to a single exclusion value. They can also be viewed as separate exclusion criteria. Furthermore, it is imaginable to check other exclusion criteria that red-eye defects cannot be present in the image data.

When selecting the exclusion criteria, it is important to observe that checking these criteria must be possible based on low-resolution image data, because computing time can only be saved in a meaningful manner if very few image data can be analyzed very quickly to determine whether a red-eye detection method shall be applied at all or if such defects can be excluded from the outset. If checking the exclusion criteria were to be carried out using the high-resolution image data, the savings in computing time would not be sufficient to warrant checking additional criteria prior to the defect detection process. In this case, it would be more prudent to carry out a red-eye detection process for all photos. However, if the low-resolution image contents are used to check the exclusion criteria, the analysis can be done very quickly such that much computing time is saved, because the elaborate red-eye detection process based on the high-resolution data does not need to be carried out for each image.

If the image data are not yet present in digital format, the data of the high-resolution image content need now be determined from all images in a step 12. With photographic films, this is typically accomplished by scanning, using a high-resolution area CCD. However, it is also possible to use CCD lines or corresponding other sensors suitable for this purpose.

If the pre-analysis has determined that the red-eye exclusion value is very low, it can be assumed that no red-eye defects can be present in the image. The other image processing methods such as sharpening or contrast editing will be started without carrying out a red-eye detection process for the respective image. However, if in step 13 it is determined that red-eye defects cannot be excluded from the outset, the high-resolution image data will be analyzed to determine, whether certain prerequisites or indications for the presence of red-eye defects are at hand and the actual defect detection process will start.

It is advantageous that these prerequisites and/or indications are checked independent of one another. To save computing time, it is particularly advantageous to analyze them simultaneously. For example, in a step 14, the high-resolution image data are analyzed to determine, whether white areas can be found in them. A color value W_{FA} is determined for these white areas in a step 15, where said color value is a measure for how pure white these white areas are. In addition, a shape value W_{FO} is determined in step 16 that indicates, whether these found white areas can approximately correspond to the shape of a photographed eyeball or a light reflection in an eye or not. Color value and shape value are combined to a whiteness value in step 17, whereby a weighting of these values may be carried out as well. Simultaneously, red areas are determined in a step 18 that are assigned color and shape values as well in steps 19 and 20, respectively. From these, the redness value is determined in a step 21. The shape value for red areas refers to the question, whether the shape of the found red area corresponds approximately to the shape of a red-eye defect.

An additional, simultaneously carried out step 22 determines shadow outlines in the image data. This can be done, for example, by searching for parallel running contour lines whereby one of these lines is bright and the other is dark. Such dual contour lines are an indication that a light source is throwing a shadow. If the brightness/darkness difference is particularly great, it can be assumed that the light source producing the shadow was the flash of a camera. In this manner, the shadow value reflecting this fact and determined in a step 23 provides information, whether the probability for a flash is high or not.

The image data are analyzed for the occurrence of skin areas in an additional step 24. If skin areas are found, a color value—that is, a value that provides information how close the color of the skin area is to a skin tone color—is determined from these areas in a step 25. Simultaneously, a size value, which is a measure for the size of the skin area, is determined in a step 26. Also simultaneously, the side ratio, that is, the ratio of the long side of the skin area to its short side, is determined in a step 27. Color value, size value and side ratio are combined to a face value in a step 28, where said face value is a measure to determine how closely the determined skin area resembles a face in color size and shape.

Whiteness value, redness value, shadow value and face value are combined to a red-eye candidate value W_{RAK} in a step 29. It can be assumed that the presence of white areas, red areas, shadow outlines and skin areas in digital images indicates a good probability that the found red areas can be valued as red-eye candidates if their shape supports this assumption. When generating this value for a red-eye candidate, other conditions for the correlation of whiteness value, redness value and face value may be entered as well.

For example, a factor may be introduced that provides information, whether the red area and the white area are adjacent to one another or not. It may also be taken into account, whether the red and white areas are inside the determined skin area or are far away from it. These correlation factors can be integrated in the red-eye candidate value. An alternative to the determination of candidate values would be to feed color values, shape values, shadow value, size value, side ratio, etc. together with the correlation factors into a neural network and to obtain the red-eye candidate value from it.

Finally, the obtained red-eye candidate value is compared to a threshold in a step 30. If the value exceeds the threshold, it is assumed that red-eye candidates are present in the image. A step 31 then investigates, whether these red-eye candidates can indeed be red-eye defects. In this step, the red-eye candidates and their surroundings can, for example, be compared to the density profile of actual eyes in order to conclude, based on similarities, that the red-eye candidates are indeed located inside a photographed eye.

An additional option for analyzing the red-eye candidates is to search for two corresponding candidates with almost identical properties that belong to a pair of eyes. This can be done in a subsequent step 32 or as an alternative to step 31 or simultaneous to it. If this verification step is selected, only red-eye defects in faces photographed from the front can be detected. Profile shots with only one red eye will not be detected. However, since red-eye defects generally occur in frontal pictures, this error may be accepted to save computing time. If the criteria recommended in steps 31 and 32 are used for the analysis, a step 33 determines an agreement degree of the found candidate pairs with eye criteria. In step 34, the agreement degree is compared to a threshold in order to decide, whether the red-eye candidates are with a great degree of probability red-eye defects or not. If there is no great degree of agreement, it must be assumed that some other red image contents were found that are not to be corrected. In this case, processing of the image continues using other image processing algorithms without carrying out a red-eye correction.

However, if the degree of agreement of the candidates with eye criteria is relatively great, a face recognition process is applied to the digital image data in a subsequent step 35, where a face fitting to the candidate pair shall be sought. Building a pair from the candidates offers the advantage that the orientation of the possible face is already specified. The disadvantage is—as has already been mentioned—that the red-eye defects are not detected in profile photographs. If this error cannot be accepted, it is also possible to start a face recognition process for each red-eye candidate and to search for a potential face that fits this candidate. This requires more computing time but leads to a reliable result. If no face is found in a step 36 that fits the red-eye candidates, it must be assumed that the red-eye candidates are not defects, the red-eye correction process will not be applied and instead, other image processing algorithms are started. However, if a face can be determined that fits the red-eye candidates, it can be assumed that the red-eye candidates are indeed defects, which will be corrected using a typical correction process in a correction step 37. The previously described methods using density progressions may, for example, be used as a suitable face recognition method for the analysis of red-eye candidates. As a matter of principle, however, it is also possible to use simpler methods such as skin tone recognition and ellipses fits. However, these are more prone to errors.

There has thus been shown and described a novel method for the automatic detection of red-eye defects in photographic image data which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method for the automatic detection of red-eye defects in photographic image data, said method comprising the steps of:
(a) analyzing image and/or recording data independently of one another for several specified indications and/or prerequisites;
(b) determining a value representative of the presence of each of the individual indications and/or prerequisites;
(c) combining the determined values to produce an overall evaluation;
(d) rendering a decision about the presence of potential red-eye defects based upon the overall evaluation;
(e) locating the potential red-eye defects; and
(f) rendering a decision based upon analysis criteria,
whether there are, in fact, red-eye defects.

2. Method as set forth in claim 1, wherein the values are determined as probabilities.

3. Method as set forth in claim 2, wherein the overall evaluation is carried out by computing an overall probability and the decision is rendered by comparison with a prescribed threshold.

4. Method as set forth in claim 1, wherein the determined values are weighted.

5. Method as set forth in claim 1, wherein the overall evaluation is carried out using a neural network.

6. Method as set forth in claim 5, wherein the decision in step (d) is rendered using a neural network.

7. Method as set forth in claim 1, wherein said indications and/or prerequisites are analyzed simultaneously.

8. Method as set forth in claim 1, further comprising the step of analyzing exclusion criteria that, if present, exclude the presence of red-eye defects.

9. Method as set forth in claim 8, wherein the process for automatic detection of red-eye defects is automatically terminated if one of the exclusion criteria is present.

10. Method as set forth in claim 1, wherein one of the prerequisites is the existence of a flash photograph.

11. Method as set forth in claim 10, wherein the existence of the flash photograph is determined based on recording data that are stored on the photographic film together with the digital image data when taking the photograph.

12. Method as set forth in claim 10, wherein the existence of the flash photograph is determined based on an image analysis.

13. Method as set forth in claim 1, wherein one of the indications are adjacently positioned skin tones.

14. Method as set forth in claim 1, wherein one of the indications is the recognition of a face.

15. Method as set forth in claim 1, wherein one of the prerequisites is locating a round, red spot.

16. Method as set forth in claim 1, wherein one of the prerequisites is locating small, round, red areas with a white dot of a light reflection disposed inside the red areas.

17. Method as set forth in claim 1, wherein one of the indications is the frequency of structures in the image that can be determined by the decline of the Fourier transformed signals.

18. Method as set forth in claim 1, further comprising the step of analyzing the red-eye defects if a positive decision is rendered about the existence of red-eye defects.
